(19) United States
(12) Patent Application Publication
(10) Pub. No.: US 2005/0139197 A1
(43) Pub. Date: Jun. 30, 2005

(54) Fuel supply apparatus and control method for internal combustion engine

(75) Inventors: Hironori Ohhashi, Isesaki-shi (JP); Hiroshi Okada, Isesaki-shi (JP); Masato Kumagai, Isesaki-shi (JP)

Correspondence Address: FOLEY AND LARDNER;SUITE 500, 3000 K STREET NW, WASHINGTON, DC, 20007, US

(73) Assignee: HITACHI, LTD.

(21) Appl. No.: 11/019,197

(22) Filed: Dec. 23, 2004

(30) Foreign Application Priority Data
Dec. 26, 2003 (JP) 2003-432995

(51) Int. Cl. F02M 33/02

(52) U.S. Cl. 123/520

(57) ABSTRACT

A canister, a cut valve which closes a fresh air intake of the canister, and a pressure sensor which detects a pressure in a fuel vapor path shut off by closing a purge control valve and the cut valve are disposed at the inside of a fuel tank, and a fuel supply control unit which controls the cut valve and the purge control valve, and which carries out a leak diagnosis on the basis of a detected result of the pressure sensor is disposed at the inside of the fuel tank.

### BACKGROUND OF THE INVENTION

1. Field of the Invention

The present invention relates to a fuel supply apparatus supplying fuel to an internal combustion engine and a method for controlling the fuel supply apparatus.

2. Description of the Related Art

Japanese Unexamined Patent Publication No.07-091330 discloses a fuel vapor purge system which traps fuel vapor generated inside a fuel tank in a canister, and which purges the fuel vapor trapped in the canister, into an intake passage via a purge passage at which a purge control valve is provided.

Further, the above Publication discloses a method for diagnosing whether there is any leak at the above-described fuel vapor purge system.

In the leak diagnosis, a drain cut valve is provided at a fresh air intake of the canister, and a discharge opening of an air pump is connected along the purge passage at the down stream than the purge control valve.

Here, due to air being supplied to the purge passage by the air pump in a state in which the drain cut valve and the purge control valve are closed, a diagnostic zone including the purge passage, the canister, and the fuel tank is pressurized.

Then, it is diagnosed whether there is any leak on the basis of a change of pressure in the diagnostic zone accompanying the pressurization.

By the way, in addition to providing the fuel vapor purge system, when a drain cut valve, an air pump, a pressure sensor, or the like which are for a leak diagnosis are provided thereat, there has been the problem that the number of controlled system parts and sensors in a fuel supply apparatus are made large, and the wirings with a control unit are made longer and complicated.

### SUMMARY OF THE INVENTION

Therefore, an object of the present invention is to configure wirings between a control unit and controlled system parts/sensors so as to be short and simple in a fuel supply apparatus.

In order to achieve the above described object, in the present invention, devices and a control unit are disposed in a fuel tank, and the devices in the fuel tank are controlled by the control unit disposed in the fuel tank.

The other objects and features of this invention will become understood from the following description with reference to the accompanying drawing.

### BRIEF EXPLANATION OF THE DRAWINGS

FIG. 1 is a block diagram of a fuel supply apparatus in an embodiment;

FIG. 2 is a functional block diagram of a fuel supply control unit in the embodiment; and

FIG. 3 is a sectional view of the fuel supply control unit in the embodiment.

### PREFERRED EMBODIMENT

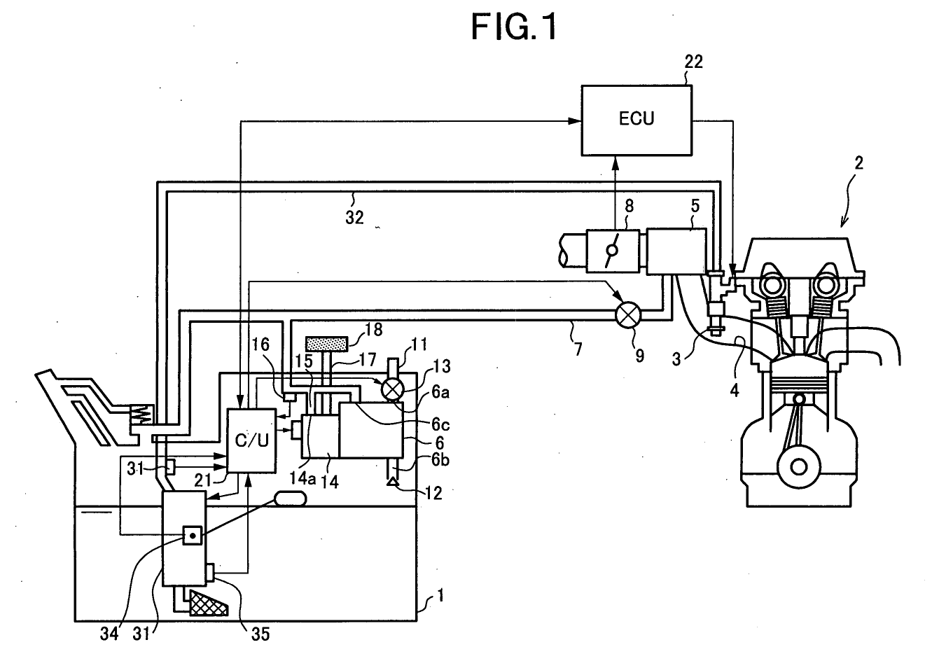

FIG. 1 shows a fuel supply apparatus having a fuel vapor purge system for an internal combustion engine on a vehicle.

A fuel pump 31 is installed in a fuel tank 1.

Fuel discharged from the fuel pump 31 is supplied to a fuel injection valve 3 via a fuel piping 32.

A fuel pressure sensor 33 detecting a fuel pressure in the fuel piping 32 is provided at a portion, which is positioned in the fuel tank 1, of the fuel piping 32.

A fuel supply control unit 21 installed inside the fuel tank 1 controls to drive the fuel pump 31 in accordance with a fuel pressure detected at the fuel pressure sensor 33.

Further, detection signals of a fuel level sensor 34 and a fuel temperature sensor 35 are inputted to the fuel supply control unit 21.

The fuel injection valve 3 is provided at an intake port 4 of each cylinder of an internal combustion engine 2, and is driven to open by an injection pulse signal outputted from an engine control unit 22.

Note that the fuel supply control unit 21 and the engine control unit 22 are configured so as to be capable of intercommunication via a communication line.

Purge air including fuel vapor which has been purged from a canister 6 is supplied to an intake air collector 5 at the upstream side of the fuel injection valve 3 via a purge passage 7.

A throttle valve 8 is installed at the upstream side of the intake air collector 5.

An intake air flow of the internal combustion engine 2 is adjusted in accordance with an opening of the throttle valve 8.

A purge control valve 9 is installed along the way of the purge passage 7.

A purge air amount supplied to the internal combustion engine 2 via the purge passage 7 is controlled in accordance with an opening of the purge control valve 9.

The canister 6 is one in which adsorbent such as activated charcoal or the like is filled in a container, and is installed at the upper portion in the fuel tank 1.

A fresh air intake pipe 11 is connected to a fresh air intake 6a provided at the canister 6.

The fresh air intake pipe 11 is installed so as to pass through the wall of the fuel tank 1 and to be extended up to the exterior of the fuel tank 1, and is released in the atmosphere outside of the fuel tank 1.

Further, a fuel vapor inlet 6b released in the fuel tank 1 via a cut valve 12 is provided at the canister 6.

The cut valve 12 is a mechanical valve which usually opens and closes at the time of being sunk in liquid.

Fuel vapor generated inside the fuel tank 1 is absorbed into the adsorbent in the canister 6 via the fuel vapor inlet 6b when the cut valve 12 is opened.

On the other hand, the purge passage 7 is connected to a fuel vapor outlet 6c of the canister 6.

Here, the purge control valve 9 is controlled by the fuel supply control unit 21.

The fuel supply control unit 21 controls to open the purge control valve 9 when a purge permission condition is established during an operation of the internal combustion engine 2.

When the purge control valve 9 opens, an intake negative pressure of the internal combustion engine 2 acts on the canister 6, and as a result, the fuel vapor which has been absorbed in the canister 6 is detached by the fresh air, which is introduced through the fresh air intake 6a.

Then, the purge gas including the detached fuel vapor is sucked in the intake air collector 5 through the purge passage 7.

Further, in the present embodiment, a function of diagnosing whether there is any leak in the fuel vapor path from the fuel tank 1 up to the purge control valve 9 is provided.

For the leak diagnosis, a drain cut valve 13 is provided at a portion, which is positioned in the fuel tank 1, of the fresh air intake pipe 11, and an air pump 14 supplying air into the purge passage 7 is installed in the fuel tank 1.

The air pump 14 is disposed in the vicinity of the canister 6 in the fuel tank 1,.

A discharge opening 14a of the air pump 14 and the purge passage 7 in the fuel tank 1 are connected through an air supply pipe 15.

Note that it can be configured such that air is supplied into the fuel tank 1 by the air pump 14 due to the discharge opening 1 4a of the air pump 14 being released inside the fuel tank 1.

Further, one end of a suction pipe 17 which is installed so as to pass through the wall of the fuel tank 1 and to be extended up to the exterior is connected to the suction port of the air pump 14, and the other end of the suction pipe 17 is released into the atmosphere via an air cleaner 18.

Moreover, a pressure sensor 16 detecting an internal pressure of the purge passage 7 is provided in the fuel tank 1.

The drain cut valve 13 and the air pump 14 are controlled by the fuel supply control unit 21, and a detection signal of the pressure sensor 16 is inputted to the fuel supply control unit 21.

The fuel supply control unit 21 shuts the purge control valve 9 and the drain cut valve 13 after stopping the internal combustion engine 2, and closes the fuel vapor path from the fuel tank 1 up to the purge control valve 9, and next, supplies air to the closed fuel vapor path due to the air pump 14 being started.

Here, in a case in which there is no leak in the closed fuel vapor path, a pressure detected at the pressure sensor 16 rises up to a predetermined pressure.

Accordingly, in a case in which a pressure detected at the pressure sensor 16 does not reach the predetermined pressure, generation of leak is estimated.

After the closed fuel vapor path is pressurized up to the predetermined pressure, the air pump 14 is stopped, and leak can be diagnosed on the basis of a pressure drop level and a pressure drop rate thereafter. Further, decompression is carried out due to air in the closed fuel vapor path being sucked by the air pump 14, and the pressure is reduced, and leak can be diagnosed on the basis of a change of pressure at the time of the decompression, or a pressure rise level and a pressure rise rate after stopping the decompression.

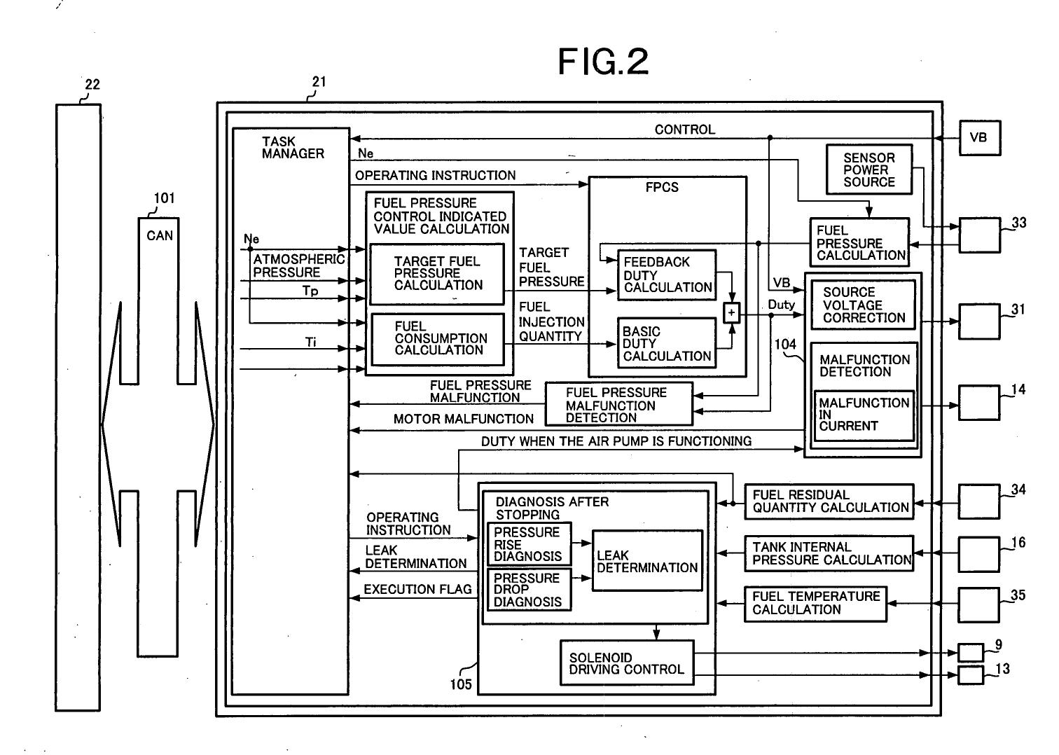

Here, the control function of the fuel supply control unit 21 will be described in accordance with the functional block diagram in FIG. 2.

The fuel supply control unit 21 and the engine control unit 22 are configured so as to be capable of intercommunication via a network 101.

The engine control unit 22 transmits information on an engine rotational speed Ne, an atmospheric pressure, a basic fuel injection quantity Tp, a fuel injection quantity Ti by a fuel injection valve, a number of injection cylinders, or the like with respect to the fuel supply control unit 21.

On the other hand, the fuel supply control unit 21 transmits information on a pressure in the fuel tank, a result of malfunction detection for a pump current, a fuel level, or the like with respect to the engine control unit 22.

At a fuel pressure control indicated value operation part 102 of the fuel supply control unit 21, a target fuel pressure and a fuel consumption are calculated on the basis of the information on an engine rotational speed Ne, an atmospheric pressure, a basic fuel injection quantity Tp, a fuel injection quantity Ti, a number of injection cylinders, or the like.

At a fuel pump control unit (FPCM) 103, a feedback duty is calculated on the basis of a deviation between a fuel pressure detected at the fuel pressure sensor 33 and the target fuel pressure, and a basic duty is calculated on the basis of the fuel consumption.

Then, due to the sum of the feedback duty and the basic duty being outputted to a motor driving circuit 104, the fuel pump 31 is driven.

Further, a function of detecting malfunction in electric current in the fuel pump 31 is provided at the motor driving circuit 104, and when malfunction is detected, a signal denoting that the electric current in the fuel pump 31 is abnormal is transmitted to the engine control unit 22.

Further, when an operating instruction for a leak diagnosis is outputted from the engine control unit 22 to the fuel supply control unit 21, a purge control unit 105 of the fuel supply control unit 21 controls the air pump 14, the purge control valve 9, and the cut valve 13, and carries out a leak diagnosis on the basis of detection signals of the pressure sensor 16 and the fuel temperature sensor 35. Then, the result of the leak diagnosis is outputted to the engine control unit 22.

Moreover, the fuel supply control unit 21 calculates a fuel level (residual quantity) on the basis of a detection signal of the fuel level sensor 34, and outputs the signal of the fuel level to the engine control unit 22.

In accordance with the above-described embodiment, the canister 6 configuring the fuel vapor purge system, and the drain cut valve 13, the air pump 14, and the pressure sensor 16 which are for a leak diagnosis are disposed in the fuel tank 1, and the air pump 14 is disposed in the vicinity of the canister 6.

Therefore, the overall length of the piping configuring the fuel vapor purge system can be shortened.

Further, because the coupling portions between the canister 6 and respective pipings and the coupling portions between the air supply path and the fuel vapor path through the air pump 14 are disposed in the space in the fuel tank 1, even in a case in which a leak is brought about at the coupling portion, fuel vapor leaks in the fuel tank 1, and leaking of fuel vapor into the atmosphere can be avoided.

Moreover, because the drain cut valve 13, the air pump 14 and the pressure sensor 16, and the fuel supply control unit 21 are arranged in the vicinity, handling of a harness is simplified.

Further, provided that it is configured such that the both control units 21 and 22 have information in common by communication between the fuel supply control unit 21 and the engine control unit 22, the signal lines between the both control units 21 and 22 can be simplified.

Moreover, the fuel supply control unit 21, the air pump 14, and the canister 6 disposed in the fuel tank 1 can be integrated, and in accordance therewith, the spatial efficiency can be improved.

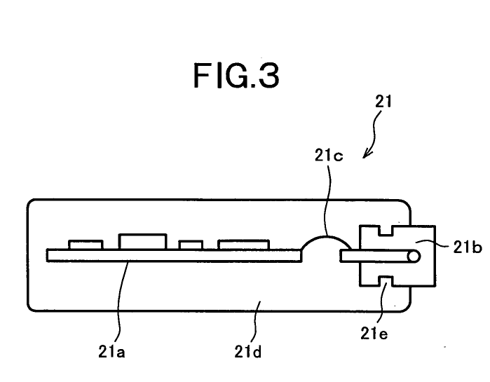

The fuel supply control unit 21 is configured as shown in FIG. 3, which can prevent fuel from permeating the inside of the control unit 21.

In the fuel supply control unit 21 shown in FIG. 3, a circuit substrate 21 a and a connector 21b are connected with a bonding wire 21c, and the circuit substrate 21a, the bonding wire 21c, and the connector 21b are sealed in a resin mold 21d.

Grooves 21e which function as stoppers for preventing the connector being slipped off, and which are for preventing fuel from permeating are formed at the basic terminal side of the connector 21b.

In the above-described embodiment, it is configured such that a leak diagnosis is carried out on the basis of a detected result at the pressure sensor 16. However, the pressure sensor 16 is omitted, and a leak diagnosis may be carried out on the basis of a load on the air pump 14.

The entire contents of Japanese Patent Application NO. 2003-432995, filed Dec. 26, 2003 are incorporated herein by reference.

While only selected embodiments have been chosen to illustrate the present invention, it will be apparent to these skilled in the art from this various change and modification can be made herein without departing from the scope of the invention as defined in the appended claims.

Furthermore, the foregoing description of the embodiments according to the present invention are provided for illustration only, and not for the purpose of limiting the invention as defined by the appended claims and their equivalents.

1. A fuel supply apparatus for an internal combustion engine comprising:
a fuel tank in which fuel to be supplied to the internal combustion engine is stored;
devices which are disposed in the fuel tank; and
a control unit which is disposed in the fuel tank and controls the devices.

2. A fuel supply apparatus for an internal combustion engine according to claim 1, wherein
the control unit is connected via a communication line to an engine control unit which controls the internal combustion engine.

3. A fuel supply apparatus for an internal combustion engine according to claim 1, wherein
the internal combustion engine comprises a fuel vapor purge system which traps fuel vapor generated inside the fuel tank in a canister, and which purges the fuel vapor trapped in the canister into an intake passage of the internal combustion engine via a purge passage at which a purge control valve is provided,
the canister, a cut valve which closes a fresh air intake of the canister, and a pressure sensor which detects a pressure in a fuel vapor path shut off by closing the purge control valve and the cut valve are disposed in the fuel tank, and
the control unit outputs control signals to the cut valve and the purge control valve, and calculates a pressure by inputting a detection signal of the pressure sensor, and diagnoses whether there is any leak in the fuel vapor path on the basis of a pressure detected by the pressure sensor, and outputs a signal denoting the diagnosed result.

4. A fuel supply apparatus for an internal combustion engine according to claim 3, wherein
a fuel temperature sensor which detects a fuel temperature in the fuel tank is further disposed in the fuel tank, and
the control unit calculates a fuel temperature by inputting a detection signal of the fuel temperature sensor, and diagnoses whether there is any leak in the fuel vapor path on the basis of a pressure detected by the pressure sensor and a fuel temperature detected by the fuel temperature sensor.

5. A fuel supply apparatus for an internal combustion engine according to claim 3, wherein
an air pump which changes a pressure in the fuel vapor path is further disposed in the fuel tank, and
the control unit outputs control signals to the cut valve, the purge control valve, and the air pump, and diagnoses whether there is any leak in the fuel vapor path by calculating a pressure by inputting a detection signal of the pressure sensor, and outputs a signal denoting the diagnosed result.

6. A fuel supply apparatus for an internal combustion engine according to claim 5, wherein
the air pump is connected to a portion, which is disposed in the fuel tank, of the purge passage.

7. A fuel supply apparatus for an internal combustion engine according to claim 5, wherein
the air pump carries air with respect to the inside of the fuel tank.

8. A fuel supply apparatus for an internal combustion engine according to claim 3, wherein
a cut valve which closes the intake when the intake is sunk in fuel is provided at an intake for fuel vapor of the canister.

9. A fuel supply apparatus for an internal combustion engine according to claim 3, wherein
a fuel pump is further disposed in the fuel tank, and
the control unit diagnoses whether there is any leak in the fuel vapor path, and calculates a target fuel pressure, and outputs a driving signal to the fuel pump on the basis of the target fuel pressure.

10. A fuel supply apparatus for an internal combustion engine according to claim 9, wherein
a fuel pressure sensor which detects a pressure of fuel supplied from the fuel pump is further disposed in the fuel tank, and
the control unit inputs a detection signal of the fuel pressure sensor, and calculates a pressure of fuel on the basis of the detection signal of the fuel pressure sensor, and
calculates a deviation between the target fuel pressure and the pressure of fuel detected at the fuel pressure sensor, and feedback-controls a driving signal of the fuel pump on the basis of the deviation.

11. A fuel supply apparatus for an internal combustion engine according to claim 9, wherein
the control unit detects an electric current of the fuel pump, and outputs a malfunction detection signal when the electric current of the fuel pump is abnormal.

12. A fuel supply apparatus for an internal combustion engine according to claim 3, wherein
a fuel level sensor which detects a level of fuel in the fuel tank is further disposed in the fuel tank, and
the control unit diagnoses whether there is any leak in the fuel vapor path, and calculates a level of fuel in the fuel tank by inputting a detection signal of the fuel level sensor, and outputs a signal denoting the fuel level.

13. A fuel supply apparatus for an internal combustion engine according to claim 1, wherein
the control unit is formed so as to seal a circuit substrate in a resin mold.

14. A fuel supply apparatus for an internal combustion engine comprising:
a fuel tank in which fuel to be supplied to the internal combustion engine is stored;
devices which are disposed in the fuel tank; and
control means, which are disposed in the fuel tank, for controlling the devices.

15. A method for controlling a fuel supply apparatus for an internal combustion engine comprising the steps of:
disposing devices in a fuel tank; and
controlling the devices by a control unit disposed in the fuel tank.

16. A method for controlling a fuel supply apparatus for an internal combustion engine according to claim 15, wherein
the internal combustion engine comprises a fuel vapor purge system which traps fuel vapor generated inside the fuel tank in a canister, and which purges the fuel vapor trapped in the canister into an intake passage of the internal combustion engine via a purge passage at which a purge control valve is provided,
the step of disposing devices in the fuel tank disposes the canister, a cut valve which closes a fresh air intake of the canister, and a pressure sensor which detects a pressure in a fuel vapor path shut off by closing the purge control valve and the cut valve at the inside of the fuel tank, and
the step of controlling the devices includes the following steps of:
controlling the purge control valve and the cut valve by the control unit;
calculating a pressure on the basis of a detection signal of the pressure sensor by the control unit; and
diagnosing whether there is any leak in the fuel vapor path on the basis of a pressure in the fuel vapor path by the control unit.

17. A method for controlling a fuel supply apparatus for an internal combustion engine according to claim 16, further comprising the following steps of:
disposing a fuel temperature sensor which detects a fuel temperature in the fuel tank at the inside of the fuel tank; and
calculating a fuel temperature from the fuel temperature sensor by the control unit, and
the step of diagnosing whether there is any leak
diagnoses whether there is any leak in the fuel vapor path on the basis of a pressure in the fuel vapor path and a fuel temperature by the control unit.

18. A method for controlling a fuel supply apparatus for an internal combustion engine according to claim 15, wherein
the internal combustion engine comprises a fuel vapor purge system which traps fuel vapor generated inside the fuel tank in a canister, and which purges the fuel vapor trapped in the canister into an intake passage of the internal combustion engine via a purge passage at which a purge control valve is provided,
the step of disposing devices in the fuel tank disposes the canister, a cut valve which closes a fresh air intake of the canister, a pressure sensor which detects a pressure in a fuel vapor path shut off by closing the purge control valve and the cut valve, and an air pump which changes a pressure in the fuel vapor path at the inside of the fuel tank, and
the step of controlling the devices includes the following steps of:
controlling the purge control valve, the cut valve, and the air pump by the control unit disposed inside the fuel tank;
calculating a pressure on the basis of a detection signal of the pressure sensor by the control unit; and
diagnosing whether there is any leak in the fuel vapor path on the basis of a pressure in the fuel vapor path by the control unit.

19. A method for controlling a fuel supply apparatus for an internal combustion engine according to claim 16, further comprising the following steps of:
disposing a fuel pump in the fuel tank;
calculating a target fuel pressure by the control unit; and
controlling the fuel-pump on the basis of the target fuel pressure by the control unit.

20. A method for controlling a fuel supply apparatus for an internal combustion engine according to claim 16 further comprising the following steps of:
disposing a fuel level sensor which detects a level of fuel in the fuel tank at the inside of the fuel tank;
calculating a level of fuel in the fuel tank on the basis of a detection signal of the fuel level sensor by the control unit; and
outputting a signal denoting the fuel level by the control unit.
